(19) United States
(12) Patent Application Publication
(10) Pub. No.: US 2019/0289327 A1
(43) Pub. Date: Sep. 19, 2019

(54) Method and Apparatus of Loop Filtering for VR360 Videos

(71) Applicant: MEDIATEK INC., Hsin-Chu (TW)

(72) Inventors: Sheng-Yen LIN, Hsin-Chu (TW); Jian-Liang LIN, Hsin-Chu (TW)

(21) Appl. No.: 16/286,874

(22) Filed: Feb. 27, 2019

Related U.S. Application Data
(60) Provisional application No. 62/642,175, filed on Mar. 13, 2018.

(51) Int. Cl. H04N 19/597; G06N 3/08; H04N 19/96; H04N 19/82; H04N 19/119

(52) U.S. Cl. CPC H04N 19/597; G06N 3/08; H04N 19/119; H04N 19/82; H04N 19/96

(57) ABSTRACT

Methods and apparatus of processing 360-degree virtual reality (VR360) pictures are disclosed. A target reconstructed VR picture in a reconstructed VR picture sequence is divided into multiple processing units and whether a target processing unit contains any discontinuous edge corresponding to a face boundary in the target reconstructed VR picture is determined. If the target processing unit contains any discontinuous edge: the target processing unit is split into two or more sub-processing units along the discontinuous edges; and NN processing is applied to each of the sub-processing units to generate a filtered processing unit. If the target processing unit contains no discontinuous edge, the NN processing is applied to the target processing unit to generate the filtered processing unit. A method and apparatus for CNN training process are also disclosed. The input reconstructed VR pictures and original pictures are divided into sub-frames along discontinuous boundaries for the training process.

### CROSS REFERENCE TO RELATED APPLICATIONS

The present invention claims priority to U.S. Provisional Patent Application, Ser. No. 62/642,175, filed on Mar. 13, 2018. The U.S. Provisional Patent Application is hereby incorporated by reference in its entirety.

### FIELD OF THE INVENTION

The present invention relates to picture processing for 360-degree virtual reality (VR) pictures. In particular, the present invention relates to neural network (NN) based filtering for improving picture quality in reconstructed VR360 pictures.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) pictures may be captured using a 360-degree spherical panoramic camera or multiple pictures arranged to cover all field of views around 360 degrees. The three-dimensional (3D) spherical picture is difficult to process or store using the conventional picture/video processing devices. Therefore, the 360-degree VR pictures are often converted to a two-dimensional (2D) format using a 3D-to-2D projection method, such as EquiRectangular Projection (ERP) and CubeMap projection (CMP). Accordingly, a 360-degree picture can be stored in an equirectangular projected format. The equirectangular projection maps the entire surface of a sphere onto a flat picture. The vertical axis is latitude and the horizontal axis is longitude. FIG. 1A illustrates an example of projecting a sphere 110 into a rectangular picture 112 according to equirectangular projection, where each longitude line is mapped to a vertical line of the ERP picture. FIG. 1B illustrates an example of ERP picture 114. For the ERP projection, the areas in the north and south poles of the sphere are stretched more severely (i.e., from a single point to a line) than areas near the equator. Furthermore, due to distortions introduced by the stretching, especially near the two poles, predictive coding tools often fail to make good prediction, causing reduction in coding efficiency. FIG. 1C illustrates a cube 120 with six faces, where a 360-degree virtual reality (VR) picture can be projected to the six faces on the cube according to cubemap projection. There are various ways to lift the six faces off the cube and repack them into a rectangular picture. The example shown in FIG. 1C divides the six faces into two parts (122a and 122b), where each part consists of three connected faces. The two parts can be unfolded into two strips (130a and 130b), where each strip corresponds to a continuous picture. The two strips can be joined to form a rectangular picture 140 according to one CMP layout as shown in FIG. 1C. However, the layout is not very efficient since some blank areas exist. Accordingly, a compact layout 150 is used, where a boundary 152 is indicated between the two strips (150a and 150b). However, the picture contents are continuous within each strip.

Besides the ERP and CMP projection formats, there are various other VR projection formats, such as octahedron projection (OHP), icosahedron projection (ISP), segmented sphere projection (SSP), truncated square pyramid porjection (TSP) and rotated sphere projection (RSP), that are widely used in the field.

The VR360 video sequence usually requires more storage space than the conventional 2D video sequence. Therefore, video compression is often applied to VR360 video sequence to reduce the storage space for storage or the bit rate for streaming/transmission. As is known for video coding, loop filtering is often used to reduce artifact in the reconstructed video.

In recent years, Neural Network (NN) has been widely used in various fields. Neural network is a framework for many different machine learning algorithms to work together and process complex data inputs. Such systems can learn to perform tasks by considering examples. For example, in image recognition, neural network may learn to identify images. In another example, in image noise reduction, neural network can learn to select best filter parameters to achieve optimal noise reduction. Neural network, also referred as an Artificial Neural Network (ANN), is an information-processing system that has certain performance characteristics in common with biological neural networks. A Neural Network system is made up of a number of simple and highly interconnected processing elements to process information by their dynamic state response to external inputs. The processing element can be considered as a neuron in the human brain, where each perceptron accepts multiple inputs and computes weighted sum of the inputs. In the field of neural network, the perceptron is considered as a mathematical model of a biological neuron. Furthermore, these interconnected processing elements are often organized in layers. For recognition applications, the external inputs may correspond to patterns are presented to the network, which communicates to one or more middle layers, also called ‘hidden layers’, where the actual processing is done via a system of weighted ‘connections’.

Artificial neural networks may use different architecture to specify what variables are involved in the network and their topological relationships. For example the variables involved in a neural network might be the weights of the connections between the neurons, along with activities of the neurons. Feed-forward network is a type of neural network topology, where nodes in each layer are fed to the next stage and there is connection among nodes in the same layer. Most ANNs contain some form of ‘learning rule’, which modifies the weights of the connections according to the input patterns that it is presented with. In a sense, ANNs learn by example as do their biological counterparts. Backward propagation neural network is a more advanced neural network that allows backwards error propagation of weight adjustments. Consequently, the backward propagation neural network is capable of improving performance by minimizing the errors being fed backwards to the neural network.

The NN can be a deep neural network (DNN), convolutional neural network (CNN), recurrent neural network (RNN), or other NN variations. Deep multi-layer neural networks or deep neural networks (DNN) correspond to neural networks having many levels of interconnected nodes allowing them to compactly represent highly non-linear and highly-varying functions. Nevertheless, the computational complexity for DNN grows rapidly along with the number of nodes associated with the large number of layers.

The CNN is a class of feed-forward artificial neural networks that is most commonly used for analyzing visual imagery. A recurrent neural network (RNN) is a class of artificial neural network where connections between nodes form a directed graph along a sequence. Unlike feedforward neural networks, RNNs can use their internal state (memory) to process sequences of inputs. The RNN may have loops in them so as to allow information to persist. The RNN allows operating over sequences of vectors, such as sequences in the input, the output, or both.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). VR360 video sequences can be coded using HEVC. However, the present invention may also be applicable for other coding methods.

In HEVC, one slice is partitioned into multiple coding tree units (CTU). For color pictures, a color slice may be partitioned into multiple coding tree blocks (CTB). The CTU is further partitioned into multiple coding units (CUs) to adapt to various local characteristics. HEVC supports multiple Intra prediction modes and for Intra coded CU, the selected Intra prediction mode is signalled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

FIG. 2A illustrates an exemplary adaptive Intra/Inter video encoder based on HEVC. The Intra/Inter Prediction unit 210 generates Inter prediction based on Motion Estimation (ME)/Motion Compensation (MC) when Inter mode is used. The Intra/Inter Prediction unit 210 generates Intra prediction when Intra mode is used. The Intra/Inter prediction data (i.e., the Intra/Inter prediction signal) is supplied to the subtractor 216 to form prediction errors, also called residues or residual, by subtracting the Intra/Inter prediction signal from the signal associated with the input picture. The process of generating the Intra/Inter prediction data is referred as the prediction process in this disclosure. The prediction error (i.e., residual) is then processed by Transform (T) followed by Quantization (Q) (T+Q, 220). The transformed and quantized residues are then coded by Entropy coding unit 222 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. Since a reconstructed picture may be used as a reference picture for Inter prediction, a reference picture or pictures have to be reconstructed at the encoder end as well. Consequently, the transformed and quantized residues are processed by Inverse Quantization (IQ) and Inverse Transformation (IT) (IQ+IT, 224) to recover the residues. The reconstructed residues are then added back to Intra/Inter prediction data at Reconstruction unit (REC) 228 to reconstruct video data. The process of adding the reconstructed residual to the Intra/Inter prediction signal is referred as the reconstruction process in this disclosure. The output picture from the reconstruction process is referred as the reconstructed picture. In order to reduce artefacts in the reconstructed picture, in-loop filters including Deblocking Filter (DF) 230 and Sample Adaptive Offset (SAO) 232 are used. The filtered reconstructed picture at the output of all filtering processes is referred as a decoded picture in this disclosure. The decoded pictures are stored in Frame Buffer 240 and used for prediction of other frames.

FIG. 2B illustrates an exemplary adaptive Intra/Inter video decoder based on HEVC. Since the encoder also contains a local decoder for reconstructing the video data, some decoder components are already used in the encoder except for the entropy decoder. At the decoder side, an Entropy Decoding unit 260 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 250 is different from that in the encoder side since the Inter prediction only needs to perform motion compensation using motion information derived from the bitstream. Furthermore, an Adder 214 is used to add the reconstructed residues to the Intra/Inter prediction data.

It is desirable to develop neural network based filtering methods to improve picture quality in reconstructed VR360 video sequences.

### BRIEF SUMMARY OF THE INVENTION

Methods and apparatus of processing 360-degree virtual reality (VR360) pictures are disclosed. According to one method, a reconstructed VR picture sequence is received, where the reconstructed VR picture sequence is derived during encoding an original VR picture sequence or decoding coded data of the original VR picture sequence, and each original VR picture corresponds to a 2D (two-dimensional) picture projected from a 3D (three-dimensional) picture according to a target projection format. A target reconstructed VR picture in the reconstructed VR picture sequence is divided into multiple processing units and whether a target processing unit contains any discontinuous edge corresponding to a face boundary in the target reconstructed VR picture is determined. If the target processing unit contains one or more discontinuous edges: the target processing unit is split into two or more sub-processing units along said one or more discontinuous edges, where said two or more sub-processing units contain no discontinuous edge; and NN processing is applied to each of said two or more sub-processing units to generate a filtered processing unit. If the target processing unit contains no discontinuous edge: the NN processing is applied to the target processing unit to generate the filtered processing unit. The processing unit corresponds may be based on a coding tree block (CTB).

Additional information comprising prediction pictures and residue pictures derived during encoding the original VR picture sequence or decoding coded data of the original VR picture sequence may be provided to the NN processing to improve efficiency of the NN processing. The prediction pictures and the residue pictures are divided into multiple prediction processing units and multiple residue processing units respectively, and a target prediction processing unit is split into multiple target prediction sub-processing units if the target prediction processing unit contains any discontinuous edge and a target residue processing unit is split into multiple target residue sub-processing unit if the target residue processing unit contains any discontinuous edge.

When a reference pixel required for the NN processing is outside a frame boundary of a sub-frame containing the target processing unit, a padded pixel can be generated for the NN processing. The padded pixel can be generated by geometry padding, where said geometry padding generates the padded pixel from one or more spherical neighboring pixels. When the padded pixel is generated from a target spherical neighboring pixel at a fractional-pel position, the padded pixel can be interpolated from neighboring pixels of the target spherical neighboring pixel at integer positions. When the padded pixel is generated from a target spherical neighboring pixel at integer position, the padded pixel is obtained from the target spherical neighboring pixel directly. The padded pixel may also be generated from a neighboring face adjacent to the frame boundary of the sub-frame containing the target processing unit. The padded pixel at corner of the padding area is generated by extending the corner pixel of sub-frame.

In one embodiment, the padded pixels are generated on-the-fly during the NN processing. In another embodiment, the padded pixels are generated in advance prior to the NN processing is applied to the target reconstructed VR picture.

In one embodiment, the NN processing comprises NN filtering to generate an NN residue processing unit and output combining to combine the target processing unit with the NN residue processing unit to generate the filtered processing unit.

In order to identify whether the target processing unit contains one or more discontinuous edges, a label can be used with each processing unit.

In one embodiment, the NN processing may correspond to Convolutional Neural Network (CNN) processing.

The NN processing as mention here can be applied to reconstructed VR pictures in various projection formats such as cubemap projection, Equirectangular Projection (ERP), Truncated Square Pyramid Projection (TSP), Compact Icosahedron Projection (CISP), Compact Octahedron Projection (COHP), or Segmented Sphere Projection (SSP).

Methods and apparatus of neural network training process for 360-degree virtual reality (VR360) pictures are disclosed. According to one method, an original VR picture sequence associated with a virtual reality (VR) video is received, where each original VR picture corresponds to a 2D (two-dimensional) picture projected from a 3D (three-dimensional) picture according to a target projection format. Also, a reconstructed VR picture sequence is received, where the reconstructed VR picture sequence is derived during encoding the original VR picture sequence or decoding coded data of the original VR picture sequence. Each original VR picture of the original VR picture sequence is divided along one or more discontinuous boundaries in the original VR picture sequence into two or more original sub-frames to form a divided original VR picture sequence. Also, each reconstructed VR picture of the reconstructed VR picture is divided along said one or more discontinuous boundaries in the reconstructed VR picture sequence into two or more reconstructed sub-frames to form a divided reconstructed VR picture sequence. The divided original VR picture sequence and the divided reconstructed VR picture sequence are provided to an NN training process to derive trained weights associated with a loop filter.

Additional information comprising prediction pictures and residue pictures derived during encoding the original VR picture sequence or decoding coded data of the original VR picture sequence can be provided to the NN training process to improve efficiency of the NN training process. Both the prediction pictures and residue pictures are also divided into two or more sub-frames along said one or more discontinuous boundaries.

In one embodiment, the NN training process may correspond to Convolutional Neural Network (CNN) training process.

The NN training process as mention here can be applied to reconstructed VR pictures in various projection formats such as cubemap projection, Equirectangular Projection (ERP), Truncated Square Pyramid Projection (TSP), Compact Icosahedron Projection (CISP), Compact Octahedron Projection (COHP), or Segmented Sphere Projection (SSP).

### BRIEF DESCRIPTION OF THE DRAWINGS

FIG. 1A illustrates an example of projecting a sphere into a rectangular picture according to Equirectangular Projection (ERP), where each longitude line is mapped to a vertical line of the ERP picture.

FIG. 1B illustrates an example of ERP picture, where the areas in the north and south poles of the sphere are stretched more severely (i.e., from a single point to a line) than areas near the equator.

FIG. 1C illustrates a cube with six faces, where a 360-degree virtual reality (VR) picture can be projected to the six faces on the cube according to cubemap projection.

FIG. 2A illustrates an exemplary adaptive Intra/Inter video encoder based on HEVC.

FIG. 2B illustrates an exemplary adaptive Intra/Inter video decoder based on HEVC.

FIG. 3 illustrates an exemplary processing flow of CNN-based loop filter process for VR360 video pictures.

FIG. 4 illustrates an exemplary training process of CNN-based loop filtering for VR360 video pictures.

FIG. 5 illustrates an exemplary scenario of filtering process for the right-top corner position of a reconstructed picture.

FIG. 6 illustrates an example of the CNN-based filtering process, where reconstructed picture is divided into CTBs and each CTB is processed by the CNN filter using the trained weights.

FIG. 7 illustrates an example of cubemap based projection, where six faces to represent are projected to a VR360 picture in the 2D plane.

FIG. 8 illustrates an example of discontinuous boundary in the 3×2 cubemap projection layout format.

FIG. 9 illustrates an exemplary processing flow of VR360 based CNN filter process according to an embodiment of the present invention.

FIG. 10 illustrates an example of splitting process to split the training pictures along the discontinuous edge into the top sub-frames and bottom sub-frames before the CNN training process is applied.

FIG. 11 illustrates an exemplary CNN training process for the VR360 pictures in the 3×2 cubemap project layout.

FIG. 12 illustrates an example of partitioning a picture 1210 into CTBs according to the above embodiment, where a CTB containing the discontinuous edge labelled as “1” and a CTB without the discontinuous edge is labelled as “0”.

FIG. 13 illustrates an example of splitting CTBs with discontinuous edge, where the middle row of CTB with discontinuous edge in the picture are split into two sub-processing units each in the picture.

FIG. 14 illustrates an example of pixel padding according to an embodiment of the present invention.

FIG. 15 illustrates an example of geometry padding (left) and face based padding (right) are disclosed according to embodiments of the present invention for sub-frames.

FIG. 16 illustrates an example of geometry padding process using the spherical neighboring pixels.

FIG. 17 illustrates an example of face based padding for 3×2 cubemap projection format.

FIG. 18 illustrates an example of the CNN-based filtering process according to the present invention, where the CNN filter generates a CNN residue picture and the CNN residue picture is added to the reconstructed picture using pixel-wise addition to form the CNN process picture.

FIG. 19 illustrates some other projection formats including Equirectangular Projection (ERP), Truncated Square Pyramid Projection (TSP), Compact Icosahedron Projection (CISP), Compact Octahedron Projection (COHP), or Segmented Sphere Projection (SSP).

FIG. 20 illustrates an exemplary block diagram of a system incorporating the CNN filter process according to an embodiment of the present invention.

FIG. 21 illustrates an exemplary block diagram of a system incorporating the CNN training process according to an embodiment of the present invention.

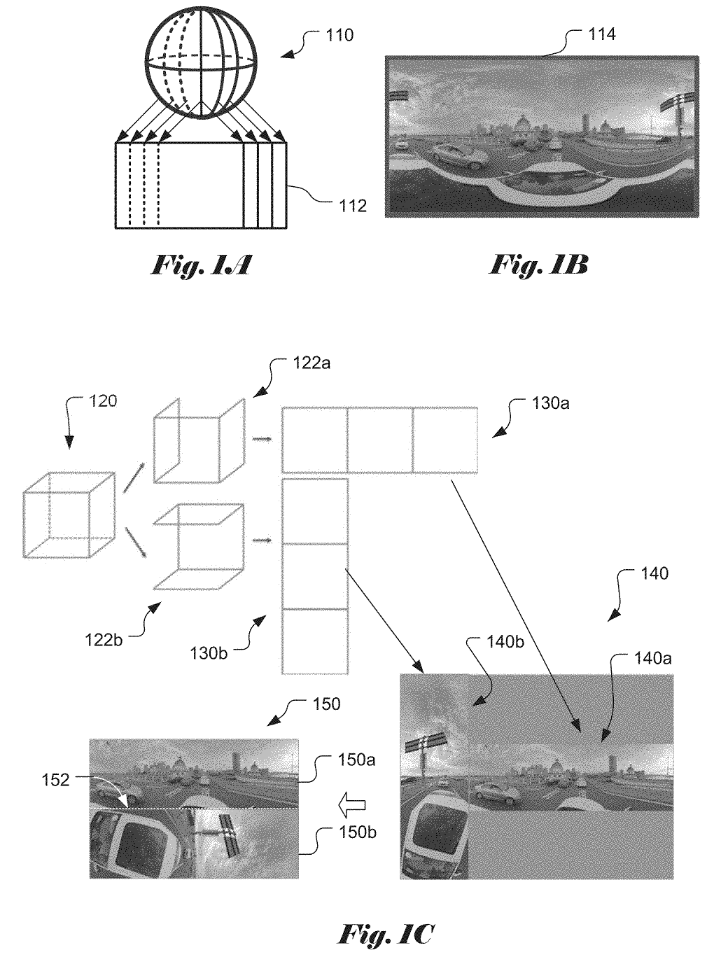

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

As mentioned above, neural networks can be applied to various picture/video processing to improve quality or accuracy. In the present invention, neural networks is applied to video coding of VR360. In particular, the present invention address the loop filtering aspect of a video coding method, such as HEVC. However, the present invention is not limited to the HEVC method.

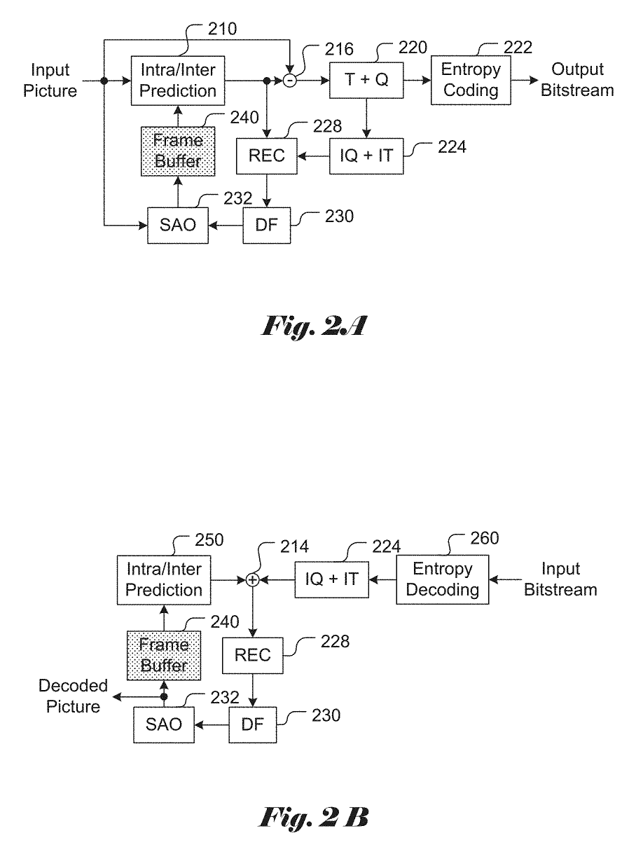

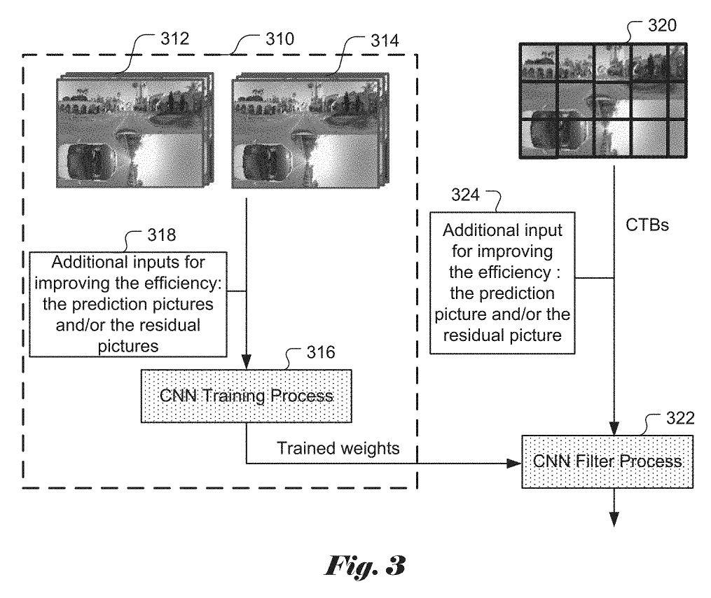

As mentioned before, a picture region (e.g. a slice) is divided into coding tree blocks (CTB) as processing units according to HEVC and each CTB is coded using a set of coding parameters. Neural network based (e.g. Convolutional Neural Network (CNN)) loop filter can be used to reduce artifacts so as to improve the coding efficiency and subjective quality of reconstructed pictures. Through the training process, a set of optimal filter parameters can be derived and used to filter pictures being processed (e.g. reconstructed pictures). The weights are often trained offline and the weights are fixed after training process. The same trained weights are used for NN filter processing at both the encoder and the decoder. In the following discussion, CNN is used as an example of NN. However, it is understood that other NN types (e.g. RNN) may also be used. The NN filter process can be applied to signals in various intermediate stages in the encoder or the decoder. For example, the NN filter process can be applied to the reconstructed signal directly from the reconstruction block 228 in FIG. 2A and FIG. 2B. The NN filter process can be applied to the reconstructed signal from the deblocking block 230 or the SAO (sample adaptive offset) block 232 in FIG. 2A and FIG. 2B. A video coding system may also include other loop filter such as ALF (adaptive loop filter). The NN filter process according to the present invention can be applied to the output from the ALF block.

FIG. 3 illustrates an exemplary processing flow of CNN-based loop filter process for VR360 video pictures. The CNN processing comprises training process 310, where original VR360 pictures 312 and reconstructed VR360 pictures 314 are provided to the CNN Training Process 316 for training. Additional inputs 318 (e.g. the prediction pictures and/or the residual pictures) for improving the efficiency may also be provided to the CNN training process 316. The prediction pictures and/or the residual pictures are generated during the encoding and/or decoding process. Through the training process, a set of trained weights will be derived, which can be used for loop filtering of an underlining picture to be processed. An underlying picture 320 is then processed by the CNN filter process 322 with the weights from the CNN training process 316. The input picture 320 is divided into CTBs (coding tree blocks), where the CTBs are processed by the video coding system including the CNN filter process 322. If additional inputs 318 (e.g. the prediction pictures and/or the residual pictures) are used in the training process, the additional inputs 324 (e.g. the prediction pictures and/or the residual pictures) can be used for the CNN filter process 322. The CNN processed picture may be further processed by the encoder or the decoder as they are intended. For example, if the CNN filter processing is applied to the DF output, the CNN processed signal will be further processed by the SAO 232. If the CNN filter processing is applied to the SAO output, the CNN processed signal will be stored in the frame buffer 240 and be used for Intra/Inter prediction.

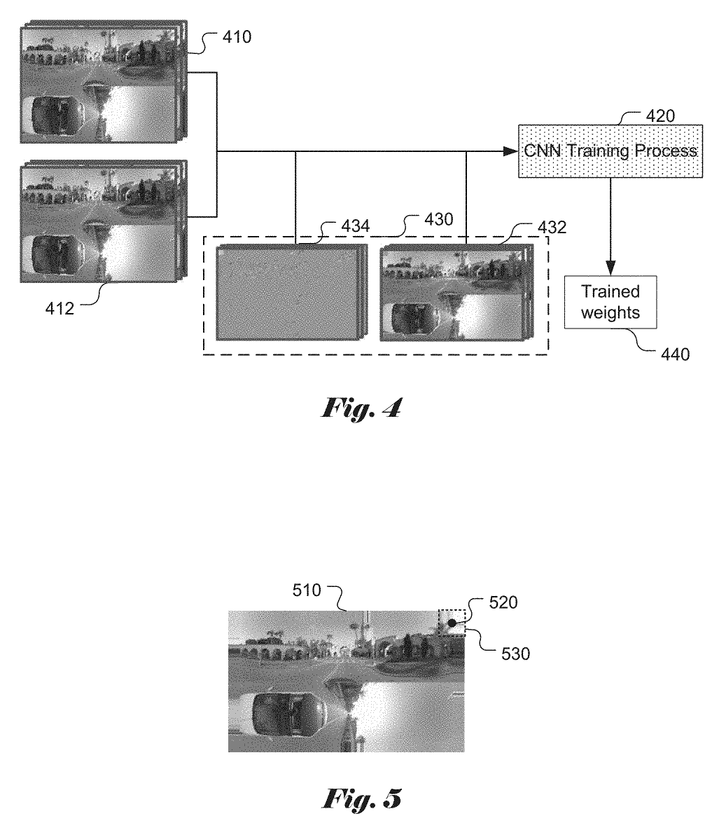

FIG. 4 illustrates an exemplary training process of CNN-based loop filtering for VR360 video pictures. The inputs provided to the CNN Training Process 420 include original VR360 pictures 410 and reconstructed VR360 pictures 412. In this example, additional inputs 430 including the prediction pictures 432 and the residual pictures 434 are also used in the training process to generate the trained weights 440.

For the CNN filter process, the reconstructed picture is first divided into processing units, such as CTBs. Each pixel in a processing unit (i.e., a CTB) is filtered by a kernel where the kernel is an Nx N window and the filter weights are according to the trained weights. If the kernel is bigger than 1×1, some of the reference pixels located near the picture boundaries could be outside the reconstructed picture. To improve the filtering efficiency, the pixel positions outside the reconstructed picture are padded by extending the pixels on picture boundaries. For example, when a pixel located at the right-top corner position of a reconstructed picture is filtered by a 3×3 kernel, some of the reference positions outside the reconstructed picture will be involved with the filter. Therefore, some pixels outside the picture boundaries need to be padded by extending the pixels on picture boundaries. Accordingly, the filtering efficiency can be improved. FIG. 5 illustrates an exemplary scenario of filtering process for the right-top corner position 520 of a padded reconstructed picture 510. Window 530 corresponds to the 3×3 kernel, where some reference pixels are outside the boundaries of the reference picture.

The CNN filter process is applied for each pixel in a processing unit (e.g. CTB). In one embodiment, the CNN process will generate CNN residue signals by applying CNN filtering using the trained weights. The CNN filtered output is then added to the reconstructed signal using pixel-wise addition to form the CNN processed signal. To improve the filtering efficiency, the prediction picture and residual picture could be used as additional input for filter process. FIG. 6 illustrates an example of the CNN-based filtering process, where reconstructed picture 610 is divided into CTBs (shown as blocks in picture 610) and each CTB is processed by the CNN filter 620 using the trained weights 622. The reconstructed picture is added to the CNN residue values 630 (i.e., the output from the CNN Filter 620) on a pixel-by-pixel basis to form the CNN processed picture 640. The prediction picture and residual picture 612 can be used as additional input for the CNN filter 620.

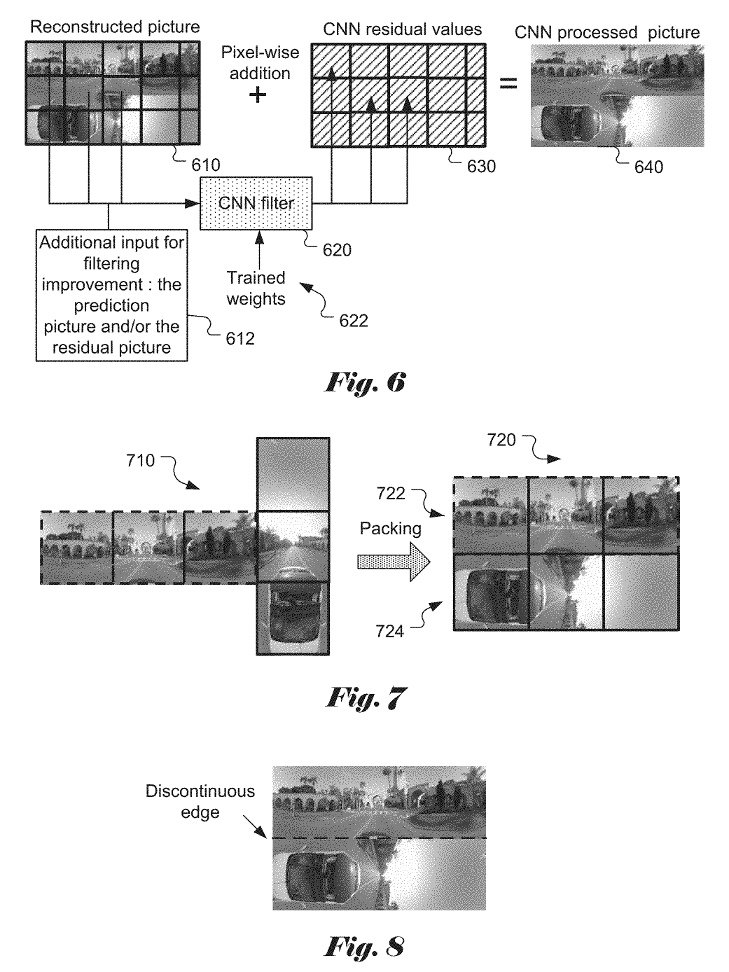

Cubemap based projection uses six faces to represent a VR360 picture in 2D plane. The six faces 710 lifted from six faces of a cube can be packed into a 3×2 layout 720 to improve coding efficiency. Top three faces form a top sub-frame 722 and bottom three faces form a bottom sub-frame 724 as shown in FIG. 7.

For cubemap based projection in VR360 videos, the discontinuous edge between the top sub-frame and bottom sub-frame in a 3×2 layout format is not a real edge in picture content as shown in FIG. 8. The trained weights would be incorrect when the pictures containing the discontinuous edge are used for CNN training process. The filtering efficiency of CNN filter process could be effected by the discontinuous edge. In order to resolve this issue, VR360 based CNN filter process is disclosed for VR360 sequences. While the 3×2 cubemap projection layout format is used to illustrate the discontinuous boundary, the discontinuous boundary also existing in other projection formats, such as Truncated Square Pyramid Projection (TSP), Compact Icosahedron Projection (CISP), Compact Octahedron Projection (COHP), and Segmented Sphere Projection (SSP). The VR360 based CNN filter process can also be applied to VR360 sequences based on other projection formats.

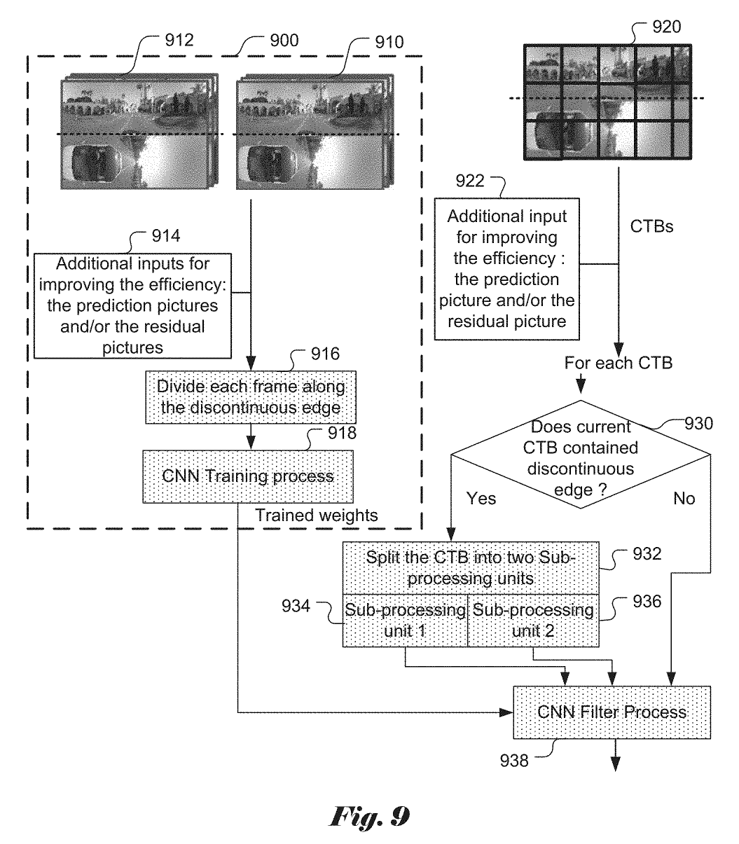

FIG. 9 illustrates an exemplary processing flow of VR360 based CNN filter process according to an embodiment of the present invention. The process 900 in FIG. 9 corresponds to the CNN training process according to the present invention. In order to overcome the discontinuous edge in a VR360 picture, each picture (original picture 910 and reconstructed picture 912) is divided along the discontinuous edge into sub-frames as shown in step 916, where the horizontal dash line indicates the discontinuous boundary. The divided sub-frames are provided to the CNN training process 918 to derive the trained filter weights. Additional inputs 914 (e.g. the prediction pictures and/or the residual pictures) for improving the efficiency may also be divided along the discontinuous edge into sub-frames as shown in step 916 and provided to the CNN training process 918. The process on the right hand side of FIG. 9 corresponds to the CNN filter processing of an input picture 920 according to the present invention. The input picture is divided into processing units (e.g. CTBs) as shown by the solid lines over the input picture. The dash line indicates the discontinuous boundary. The CNN filter process is applied on a CTB basis. Each CTB is checked for existence of discontinuous edge in step 930. If no discontinuous edge exists (i.e., the “No” path from step 930), the whole CTB is processed by the CNN filter process 938 using the trained weights. If the CTB contains discontinuous edge (i.e., the “Yes” path from step 930), the CTB is split into two sub-processing units (934 and 936) in step 932. The two processing units (934 and 936) are then processed by the CNN filter process 938 using the trained weights.

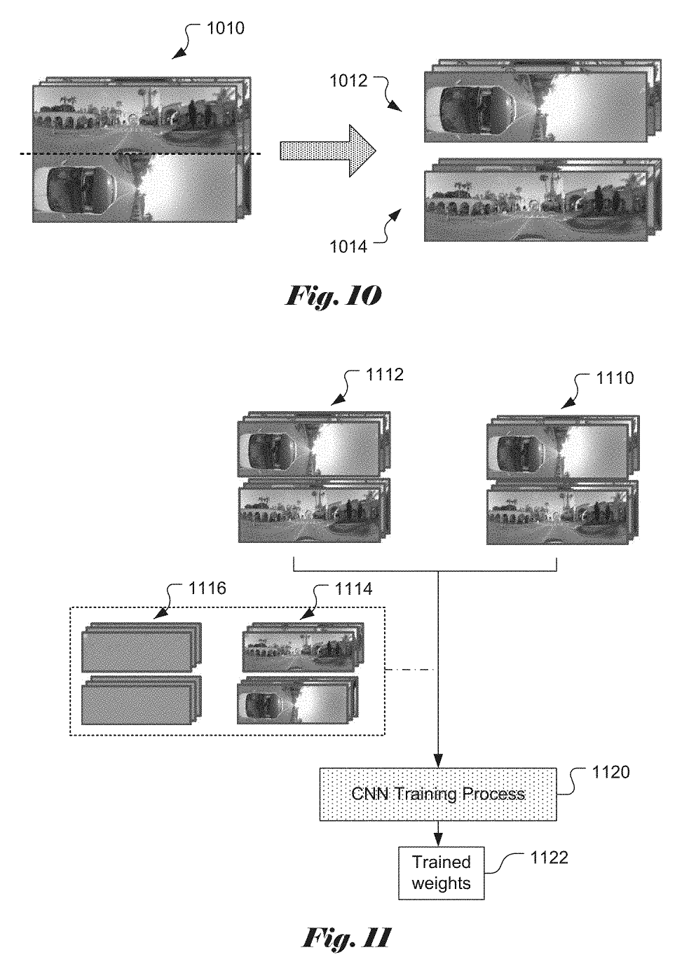

As mentioned above, in order to avoid the pictures containing discontinuous edge are used for the CNN training process, the VR360 pictures in a given layout format are divided into two or more partitions along the discontinuous edges. For example, for the cubemap projection in 3x2 layout format, there is one horizontal discontinuous edge and each picture is split into two sub-frames along the discontinuous boundary. The splitting process is applied to the training pictures 1010 (i.e., both the reconstructed pictures and the corresponding original pictures) along the discontinuous edge into the top sub-frames 1012 and bottom sub-frames 1014 before the CNN training process as shown in FIG. 10. The prediction pictures and residual pictures are also divided if they are used for CNN training process to improve the filtering efficiency. For VR360 pictures in other projection format, the VR picture may be split into different shapes and there may be more than two sub-frame for each picture.

FIG. 11 illustrates an exemplary CNN training process for the VR360 pictures in the 3×2 cubemap project layout. The input original pictures are split along the discontinuous boundary into top sub-frames and bottom sub-frames 1110. Similarly, the input reconstructed pictures are split along the discontinuous boundary into top sub-frames and bottom sub-frames 1112. Both split original pictures 1110 and reconstructed pictures 1112 are provided to the CNN training process 1120. FIG. 11 also shows additional prediction pictures and residue pictures re used for training. The prediction pictures are split along the discontinuous boundary into top sub-frames and bottom sub-frames 1114. Similarly, the residue pictures are split along the discontinuous boundary into top sub-frames and bottom sub-frames 1116. Both split prediction pictures 1114 and residue pictures 1116 are also provided to the CNN training process 1120 to generate the trained weights 1122.

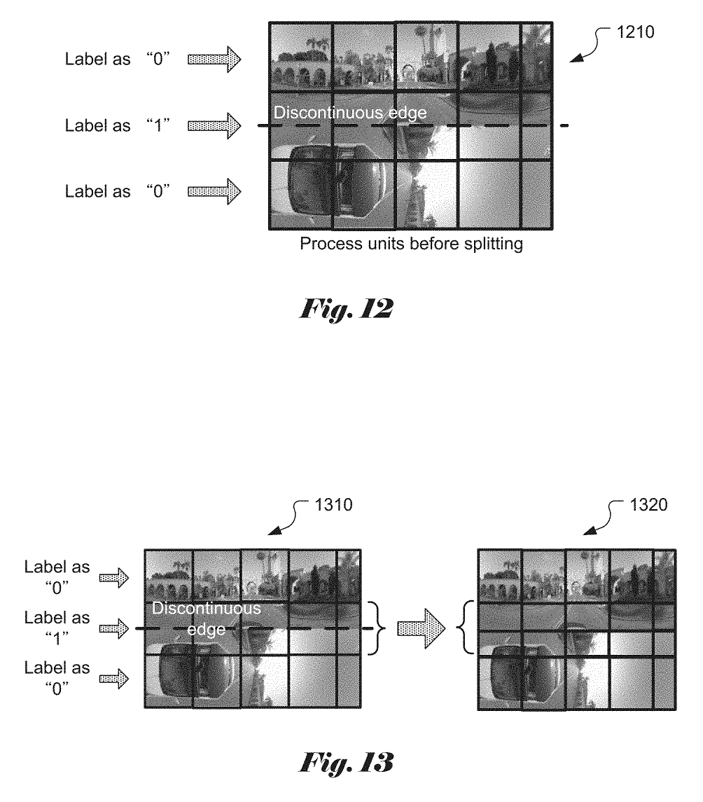

Another embodiment of the present invention is disclosed. The VR360 picture is partitioned into CTBs first. Since the underlying picture corresponds to a VR360 picture, some CTBs may contain discontinuous edges. In the VR360 based CNN filter process, the CTBs with the discontinuous edge may cause some artifacts. To avoid the CTBs which contain the discontinuous edge are filtered improperly, the CTBs should be split into two sub-processing units before performing the CNN filter process. According to an embodiment of the present invention, the CTBs of the reconstructed picture are first labeled. If a CTB contains the discontinuous edge, then the CTB is labelled as “1”. If a CTB does not contain the discontinuous edge, then the CTB is labelled as “0”. FIG. 12 illustrates an example of partitioning a picture 1210 into CTBs according to the above embodiment. The picture is divided into three rows of CTBs in this example. For CTBs in the top row and the bottom row contain no discontinuous edge. Accordingly, the CTBs in the top row and the bottom row are labelled as “0” to indicate no discontinuous edge. The CTBs in the middle row are labelled as “1” to indicate the discontinuous edge existing.

According to the present invention, the CTB labeled as “1” is split into two processing units along the discontinuous edge. FIG. 13 illustrates an example of splitting CTBs with discontinuous edge, where the middle row of CTB with discontinuous edge in picture 1310 are split into two sub-processing units each in picture 1320. As a result, the CNN filter process will not cross the discontinuous edge. The CTBs on the prediction picture and residual picture which contain the discontinuous edge are also split when they are used for CNN filter process to improve the filtering efficiency.

For VR360 videos, when performing CNN filter process to the pixels near the sub-frame boundaries, the reference positions outside the sub-frames could be padded by their spherical neighboring pixels to improve the filtering efficiency.

As mentioned before, for a kernel size larger than 1×1, the reference pixels may not be available for an underlying pixel to be processed near or at the boundary of the picture. According to an embodiment of the present invention, the reference positions outside the sub-frames could be padded in advance before CNN filter process or on-the-fly while performing the CNN filter process. These two methods lead to tradeoffs between memory usage and execution time.

In the first method, additional two sub-frame buffers are created to store the top sub-frame and bottom sub-frame of a picture. The sub-frame buffers also include extra padding area to store the padding pixels. The width of the padding area is (N−1)/2 for an N×N kernel used in CNN filter process. Two sub-frame buffers are created for the reconstructed picture, and another four sub-frame buffers are created for prediction picture and residual picture if they are used for CNN filter process.

On the other hand, the second method may reduce the memory usage, but increase the execution time.

FIG. 14 illustrates an example of pixel padding according to an embodiment of the present invention. The VR360 picture 1410 is split into a top sub-frame 1412 and a bottom sub-frame 1414. Padding pixels 1416 are added around top sub-frame 1412. Also, padding pixels 1418 are added around bottom sub-frame 1414.

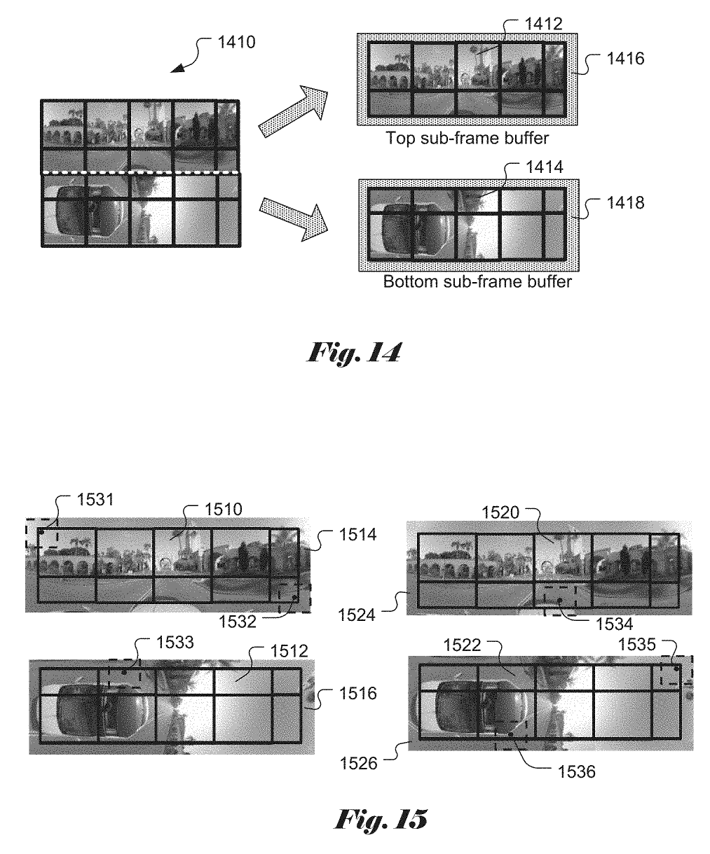

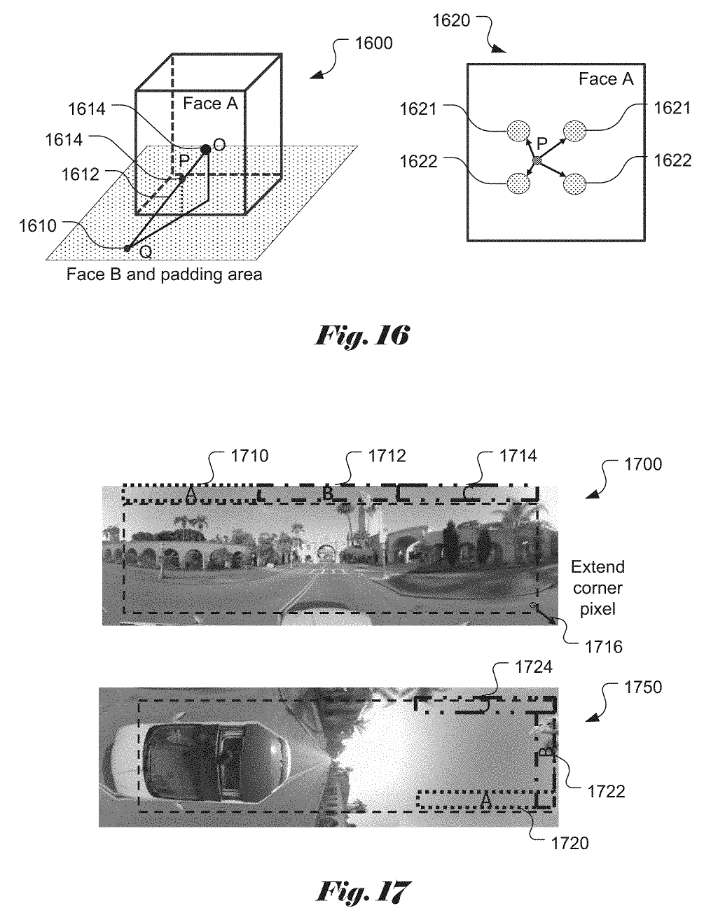

Since VR360 pictures are generated through projecting a 3D picture into a 2D format, there may exist certain relationship among neighboring faces in a VR360 picture. Accordingly, geometry padding and face based padding are disclosed according to embodiments of the present invention as shown in FIG. 15, where sub-frames 1510 and 1512 correspond to geometry padding with padded pixels 1514 and 1516. For pixels near the boundary (e.g. 1531, 1532 and 1533), all the required reference pixels for the filter kernel at the boundary pixels become available. Sub-frames 1520 and 1522 correspond to face based padding with padded pixels 1524 and 1526. For pixels near the boundary (e.g. 1534, 1535 and 1536), all the required reference pixels for the filter kernel at the boundary pixels become available.

The process of geometry padding 1600 is described in FIG. 16. In geometry padding, the spherical neighboring pixels is used to pad to padding area. The 3D picture can be represented as a picture on the surface of globe, where a pixel can always find its spherical neighboring pixels on the globe. The following example illustrates generating a padding pixel at point Q 1610 in a padding area of face B (a face on the bottom of the cube) of the cube. Point P corresponding to the intersection point of line (OQ) 1612 and face A (a front face) can be first derived, where O 1614 is the center of projection. For geometry padding, the pixel value at point P is used for padding pixel at point Q. If point P is not exactly located on an integer pixel position, then the interpolated value of four nearest pixels (1621-1624) of point P are used for padding pixel at point Q in illustration 1620 of FIG. 16.

In the face based padding, the pixels are padded from the neighboring faces in a projection layout format (e.g. a cubemap). However, depending the specific layout format, a neighboring face may have to be rotated properly before the pixels in the neighboring faces can be copied or used. Copy and rotate the neighboring faces to pad to the padding area. The corners of padding area are padded by extending four corner pixels on sub-frame area. FIG. 17 illustrates an example of face based padding for 3×2 cubemap projection format. For the top edge of the top sub-frame 1700, the neighboring faces on the top side are labelled as A 1710, B 1712 and C 1714. The corresponding neighboring face can be found from the bottom sub-frame 1750. The corresponding neighboring faces in the sub-frame 1750 are labelled as A 1720, B 1722 and 1724. As shown in FIG. 17, the neighboring face B needs to be rotated by 90 degrees clockwise and the neighboring face C needs to be rotated by 180 degrees before they can be used as padded pixels. The corner pixel 1716 of the top sub-frame 1700 is used for padding the lower-right corner of the padding area of the top sub-frame 1700.

The CNN filter process is according to the present invention performed for each pixel in a processing unit (e.g. CTB). The CNN residue values between the original picture and the reconstructed picture are produced. The CNN processed output picture is the result of performing pixel-wise addition to the reconstructed picture and the corresponding CNN residue values. To improve the filtering efficiency, the prediction picture and residual picture could be used as additional input for filter process according to the present invention. FIG. 18 illustrates an example of the VR360 based CNN filtering process according to the present invention, where reconstructed picture 1810 is divided into CTBs (shown as blocks in picture 1810). Any CTB containing a discontinuous edge is further split into two processing units. The discontinuous boundary is indicated by line 1812. Each CTB is processed by the CNN filter 1820 using the trained weights 1822 to generate CNN residue values. As shown in FIG. 18, the CTBs according to the present invention do not contain any discontinuous edge. The reconstructed picture is added to the CNN residue values 1830 on a pixel-by-pixel basis to form the CNN processed output picture 1840. The prediction picture and residual picture 1814 can be used as additional input for the CNN filter process 1820.

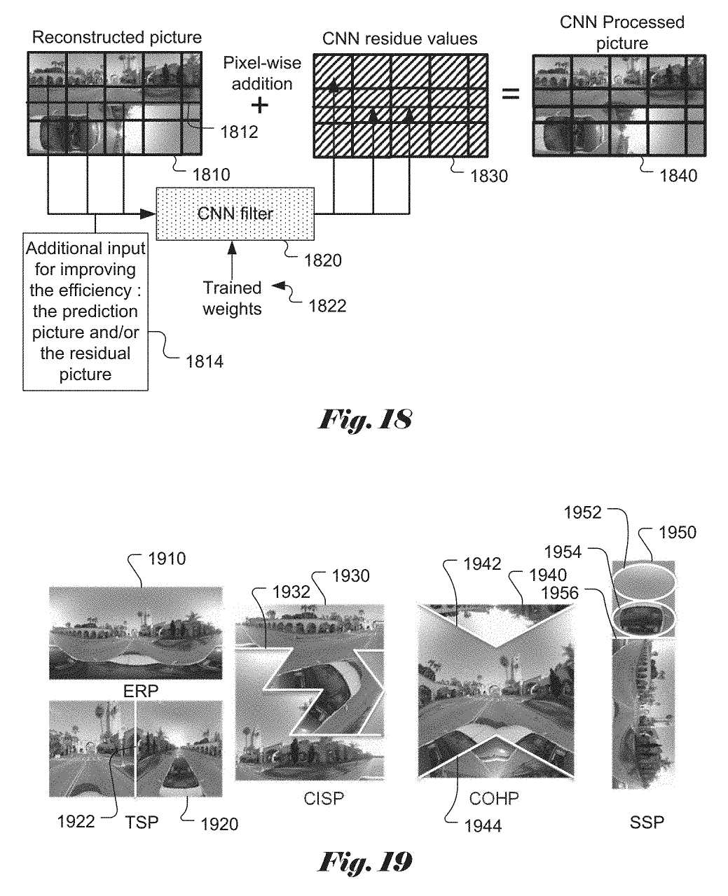

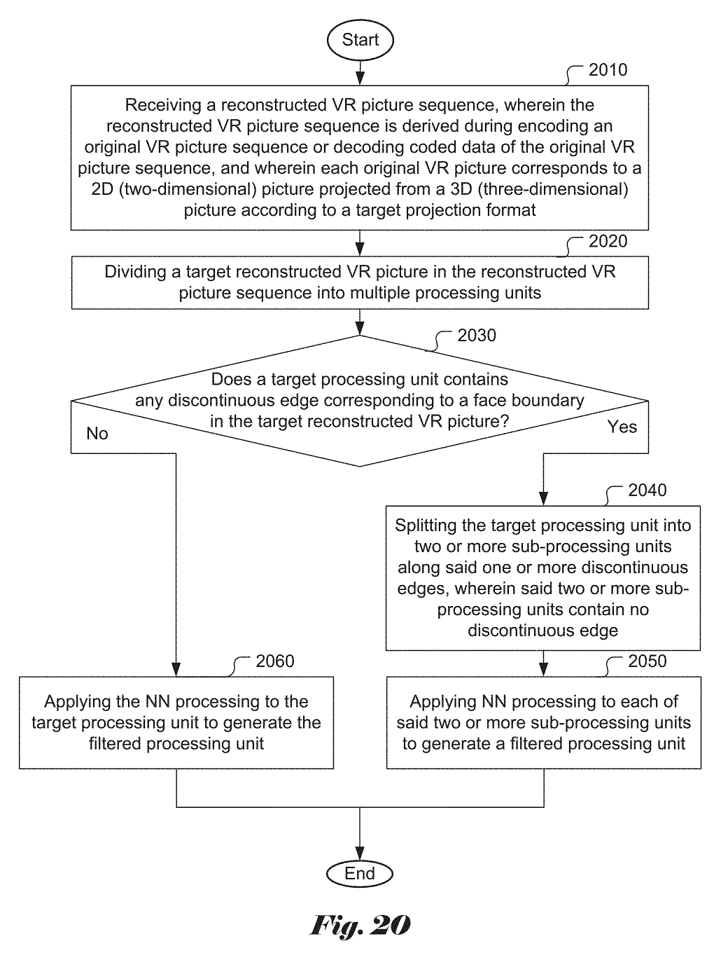

The present invention of CNN based loop filter process is illustrated using the 3×2 cubermap projection layout format as an example. However, the present invention is not limited to the 3×2 cubermap projection layout format. The CNN based loop filter process according to the present invention may also applied to other projection layout formats in FIG. 19, such as Equirectangular Projection (ERP) 1910, Truncated Square Pyramid Projection (TSP) 1920, Compact Icosahedron Projection (CISP) 1930, Compact Octahedron Projection (COHP) 1940, Segmented Sphere Projection (SSP) 1950 and so on. In order to apply CNN loop filter to a picture in different projection formats, before training and filter process, the picture could be divided into several partitions along the discontinuous edge when the discontinuous edges appear inside a picture. For the ERP format 1910, there is no discontinuous boundary within the picture. However, the picture contents on the right edge is wrapped around to the left edge. For the TSP format 1920, a vertical boundary 1922 is illustrated. For the CISP format 1930, the boundaries are in a zig-zag form 1932. For the COHP format 1940, the boundaries are indicated by lines 1942 and 1944 and for the SSP format 1950, the boundaries lines (two ellipses and 1 line) 1952, 1954 and 1956 are indicated.

Similar to the case for the 3x2 cubemap layout format, when the CNN-based loop filter is applied to other projection formats, the pictures can be divided into multiple sub-frames so that the CNN loop filter will not be applied across discontinuous boundaries. Furthermore, for boundary pixels of the sub-frames, unavailable neighboring pixels required for the loop filtering can be padded using geometry padding or face based padding.

An exemplary block diagram of a system incorporating the CNN filter process according to an embodiment of the present invention is illustrated in FIG. 20. The steps shown in the flowchart may be implemented as program codes executable on one or more processors (e.g., one or more CPUs) at the encoder side or the decoder side. The steps shown in the flowchart may also be implemented based on hardware such as one or more electronic devices or processors arranged to perform the steps in the flowchart. According to this method, a reconstructed VR picture sequence is received in step 2010, wherein the reconstructed VR picture sequence is derived during encoding an original VR picture sequence or decoding coded data of the original VR picture sequence, and wherein each original VR picture corresponds to a 2D (two-dimensional) picture projected from a 3D (three-dimensional) picture according to a target projection format. A target reconstructed VR picture in the reconstructed VR picture sequence is divided into multiple processing units in step 2020. Whether a target processing unit contains any discontinuous edge corresponding to a face boundary in the target reconstructed VR picture is checked in step 2030. If the target processing unit contains one or more discontinuous edges (i.e., the “Yes” path from step 2030), steps 2040 and 2050 are performed. If the target processing unit contains no discontinuous edge (i.e., the “No” path from step 2030), step 2060 is performed. In step 2040, the target processing unit is split into two or more sub-processing units along said one or more discontinuous edges, wherein said two or more sub-processing units contain no discontinuous edge. In step 2050, the NN processing is applied to each of said two or more sub-processing units to generate a filtered processing unit. In step 2060, the NN processing is applied to the target processing unit to generate the filtered processing unit.

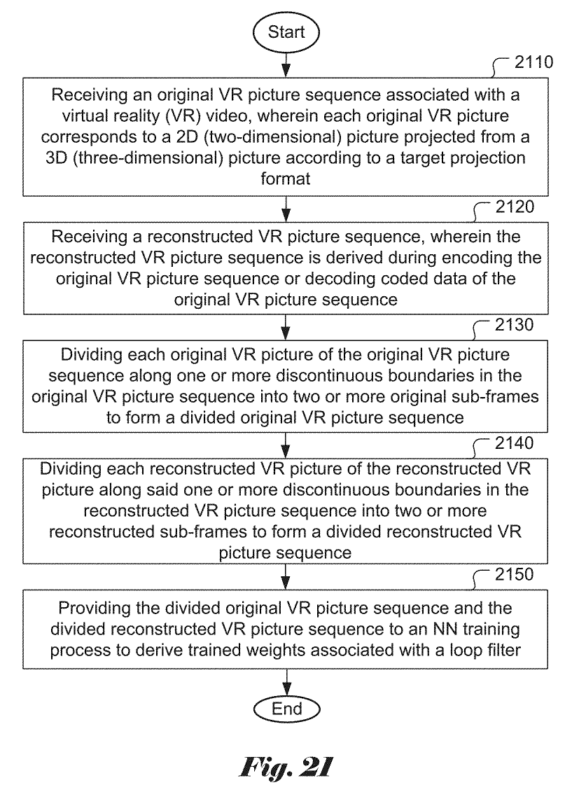

FIG. 21 illustrates an exemplary block diagram of a system incorporating the CNN training process according to an embodiment of the present invention. According to this method, an original VR picture sequence associated with a virtual reality (VR) video is received in step 2110, wherein each original VR picture corresponds to a 2D (two-dimensional) picture projected from a 3D (three-dimensional) picture according to a target projection format. Also, a reconstructed VR picture sequence is received in step 2120, wherein the reconstructed VR picture sequence is derived during encoding the original VR picture sequence or decoding coded data of the original VR picture sequence. Each original VR picture of the original VR picture sequence is divided along one or more discontinuous boundaries in the original VR picture sequence into two or more original sub-frames to form divided original VR picture sequence in step 2130. Each reconstructed VR picture of the reconstructed VR picture is also divided along said one or more discontinuous boundaries in the reconstructed VR picture sequence into two or more reconstructed sub-frames to form a divided reconstructed VR picture sequence in step 2140. The divided original VR picture sequence and the divided reconstructed VR picture sequence are provided to an NN training process to derive trained weights associated with a loop filter in step 2150.

The flowcharts shown above are intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for NN (Neural Network) based video coding or processing for a virtual reality (VR) video, the method comprising:
receiving a reconstructed VR picture sequence, wherein the reconstructed VR picture sequence is derived during encoding an original VR picture sequence or decoding coded data of the original VR picture sequence, and wherein each original VR picture corresponds to a 2D (two-dimensional) picture projected from a 3D (three-dimensional) picture according to a target projection format;
dividing a target reconstructed VR picture in the reconstructed VR picture sequence into multiple processing units;
determining whether a target processing unit contains any discontinuous edge corresponding to a face boundary in the target reconstructed VR picture;
if the target processing unit contains one or more discontinuous edges:
splitting the target processing unit into two or more sub-processing units along said one or more discontinuous edges, wherein said two or more sub-processing units contain no discontinuous edge;
applying NN processing to each of said two or more sub-processing units to generate a filtered processing unit; and
if the target processing unit contains no discontinuous edge:
applying the NN processing to the target processing unit to generate the filtered processing unit.

2. The method of claim 1, wherein additional information comprising prediction pictures and residue pictures derived during encoding the original VR picture sequence or decoding coded data of the original VR picture sequence is provided to the NN processing to improve efficiency of the NN processing.

3. The method of claim 2, wherein the prediction pictures and the residue pictures are divided into multiple prediction processing units and multiple residue processing units respectively, and a target prediction processing unit is split into multiple target prediction sub-processing units if the target prediction processing unit contains any discontinuous edge and a target residue processing unit is split into multiple target residue sub-processing unit if the target residue processing unit contains any discontinuous edge.

4. The method of claim 1, wherein each processing unit corresponds to a coding tree block (CTB).

5. The method of claim 1, wherein when a reference pixel required for the NN processing is outside a frame boundary of a sub-frame containing the target processing unit, a padded pixel is generated for the NN processing.

6. The method of claim 5, wherein the padded pixel is generated by geometry padding, wherein said geometry padding generates the padded pixel from one or more spherical neighboring pixels.

7. The method of claim 6, wherein when the padded pixel is generated from a target spherical neighboring pixel at a fractional-pel position, the padded pixel is interpolated from one or more neighboring pixels of the target spherical neighboring pixel at integer positions.

8. The method of claim 6, wherein when the padded pixel is generated from a target spherical neighboring pixel at an integer position, the padded pixel is obtained from the target spherical neighboring pixel directly.

9. The method of claim 5, wherein for the padded pixel of a pixel of the sub-frame, the padded pixel is generated from a neighboring face adjacent to the frame boundary of the sub-frame containing the target processing unit or generated by extending a corner pixel of the sub-frame.

10. The method of claim 5, wherein the padded pixel is generated on-the-fly during the NN processing.

11. The method of claim 5, wherein the padded pixel is generated in advance prior to the NN processing is applied to the target reconstructed VR picture.

12. The method of claim 1, wherein the NN processing comprises NN filtering to generate an NN residue processing unit and output combining to combine the target processing unit with the NN residue processing unit to generate the filtered processing unit.

13. The method of claim 1, wherein the target processing unit contains said one or more discontinuous edges is indicated by a label.

14. The method of claim 1, wherein the NN processing corresponds to Convolutional Neural Network (CNN) processing.

15. The method of claim 1, wherein the target projection format corresponds to cubemap projection, Equirectangular Projection (ERP), Truncated Square Pyramid Projection (TSP), Compact Icosahedron Projection (CISP), Compact Octahedron Projection (COHP), or Segmented Sphere Projection (SSP).

16. An apparatus for NN (Neural Network) based video coding or processing for a virtual reality (VR) video, the apparatus comprising one or more electronic circuitries or processors arranged to:
receive a reconstructed VR picture sequence, wherein the reconstructed VR picture sequence is derived during encoding an original VR picture sequence or decoding coded data of the original VR picture sequence, and wherein each original VR picture corresponds to a 2D (two-dimensional) picture projected from a 3D (three-dimensional) picture according to a target projection format;
divide a target reconstructed VR picture in the reconstructed VR picture sequence into multiple processing units;
determine whether a target processing unit contains any discontinuous edge corresponding to a face boundary in the target reconstructed VR picture;
if the target processing unit contains one or more discontinuous edges:
split the target processing unit into two or more sub-processing units along said one or more discontinuous edges, wherein said two or more sub-processing units contain no discontinuous edge;
apply NN processing to each of said two or more sub-processing units to generate a filtered processing unit; and
if the target processing unit contains no discontinuous edge:
apply the NN processing to the target processing unit to generate the filtered processing unit.

17. A method for NN (Neural Network) based video coding or processing for a virtual reality (VR) video, the method comprising:
receiving an original VR picture sequence associated with a virtual reality (VR) video, wherein each original VR picture corresponds to a 2D (two-dimensional) picture projected from a 3D (three-dimensional) picture according to a target projection format;
receiving a reconstructed VR picture sequence, wherein the reconstructed VR picture sequence is derived during encoding the original VR picture sequence or decoding coded data of the original VR picture sequence;
dividing each original VR picture of the original VR picture sequence along one or more discontinuous boundaries in the original VR picture sequence into two or more original sub-frames to form a divided original VR picture sequence;
dividing each reconstructed VR picture of the reconstructed VR picture sequence along said one or more discontinuous boundaries in the reconstructed VR picture sequence into two or more reconstructed sub-frames to form a divided reconstructed VR picture sequence; and
providing the divided original VR picture sequence and the divided reconstructed VR picture sequence to an NN training process to derive trained weights associated with a loop filter.

18. The method of claim 17, wherein additional information comprising prediction pictures and residue pictures derived during encoding the original VR picture sequence or decoding coded data of the original VR picture sequence is provided to the NN training process to improve efficiency of the NN training process, and wherein the prediction pictures are divided into two or more prediction sub-frames along said one or more discontinuous boundaries and the residue pictures are divided into two or more residue sub-frames along said one or more discontinuous boundaries.

19. The method of claim 18, wherein each of prediction pictures is divided along said one or more discontinuous boundaries in the prediction pictures into two or more prediction sub-frames to form a divided prediction picture sequence and each of residue pictures is divided along said one or more discontinuous boundaries in the residue pictures into two or more residue sub-frames to form a divided prediction picture sequence.

20. The method of claim 17, wherein the NN training process corresponds to a Convolutional Neural Network (CNN) training process.

21. The method of claim 17, wherein the target projection format corresponds to cubemap projection, Equirectangular Projection (ERP), Truncated Square Pyramid Projection (TSP), Compact Icosahedron Projection (CISP), Compact Octahedron Projection (COHP), or Segmented Sphere Projection (SSP).

22. An apparatus for NN (Neural Network) based video coding or processing for a virtual reality (VR) video, the apparatus comprising one or more electronic circuitries or processors arranged to:
receive an original VR picture sequence associated with a virtual reality (VR) video, wherein each original VR picture corresponds to a 2D (two-dimensional) picture projected from a 3D (three-dimensional) picture according to a target projection format;
receive a reconstructed VR picture sequence, wherein the reconstructed VR picture sequence is derived during encoding the original VR picture sequence or decoding coded data of the original VR picture sequence;
divide each original VR picture of the original VR picture sequence along one or more discontinuous boundaries in the original VR picture sequence into two or more original sub-frames to form a divided original VR picture sequence;
divide each reconstructed VR picture of the reconstructed VR picture sequence along said one or more discontinuous boundaries in the reconstructed VR picture sequence into two or more reconstructed sub-frames to form a divided reconstructed VR picture sequence; and
provide the divided original VR picture sequence and the divided reconstructed VR picture sequence to an NN training process to derive trained weights associated with a loop filter.
